(19) United States
(12) Patent Application Publication
(10) Pub. No.: US 2026/0091736 A1
(43) Pub. Date: Apr. 2, 2026

(54) CROSS RAIL CLAMPING MECHANISM

(71) Applicant: Ground Effects, LLC, Sterling Heights, MI (US)

(72) Inventor: Daniel Clermont, Windsor (CA)

(21) Appl. No.: 19/307,348

(22) Filed: Aug. 22, 2025

Related U.S. Application Data
(60) Provisional application No. 63/700,079, filed on Sep. 27, 2024.

(51) Int. Cl. B60R 9/04; F16B 2/10

(52) U.S. Cl. CPC B60R 9/04; F16B 2/10

(57) ABSTRACT

According to certain aspects of the present disclosure, a clamping mechanism for securing a cross rail to a side rail includes a frame and an inner clamp fixedly secured to the frame. The clamping mechanism includes an outer clamp pivotally attached to the frame via a pin. The outer clamp is pivotally rotatable about the pin, wherein, when in use with the side rail, the pin is adjacent to the side rail and positioned outboard of the side rail.

### CROSS REFERENCE TO RELATED APPLICATIONS

The present application claims the benefit of priority under 35 U.S.C. § 119 from U.S. Provisional Patent Application Ser. No. 63/700,079 entitled “Cross Rail Clamping Mechanism,” filed on Sep. 27, 2024, the disclosure of which is hereby incorporated by reference in its entirety for all purposes.

### TECHNICAL FIELD

The present disclosure generally relates to automotive roof racks, and more specifically relates to a cross rail clamping mechanism.

### BACKGROUND

Some vehicles are equipped with side rails mounted to the roof for supporting a storage carrier, such as a luggage carrier, to provide additional storage space beyond trunk space. Cross rails are often employed across the two mounted side rails for securing the storage carrier to the vehicle. Conventionally, the cross rails include clamps that utilize third class levers for clamping over the side rails. In such cross rails that employ third class levers, the pivot point is inboard of the side rail and above the loading mechanism and clamping surfaces. Moreover, the loading mechanism of such third class levers is located between the pivot point and the clamping faces. Since the pivot point is located above the loading mechanism and inboard of the side rail, the grip of the clamp to the bottom of the side rail does not improve with additional rotation of the outer clamp. The longer moment arm reduces the resultant forces on the clamping surfaces.

In these types of arrangements, without some type of torque limiting feature, the loading mechanism can be over torqued, which can result in deformation of the stampings, which in turn, can reduce the grip of the third class lever clamps to the side rails. Accordingly, there is a desire for cross rails that overcome the limitations of these typical cross rails stated above.

The description provided in the background section should not be assumed to be prior art merely because it is mentioned in or associated with the background section. The background section may include information that describes one or more aspects of the subject technology.

### SUMMARY

According to certain aspects of the present disclosure, a clamping mechanism for securing a cross rail to a side rail is provided. The clamping mechanism includes a frame and an inner clamp fixedly secured to the frame. The clamping mechanism includes an outer clamp pivotally attached to the frame via a pin. The outer clamp is pivotally rotatable about the pin, wherein, when in use with the side rail, the pin is adjacent to the side rail and positioned outboard of the side rail.

According to other aspects of the present disclosure, a cross rail for securing to a side rail is provided. The cross rail includes at least one clamping mechanism. The at least one clamping mechanism includes a frame and an inner clamp fixedly secured to the frame. The at least one clamping mechanism includes an outer clamp pivotally attached to the frame via a pin. The outer clamp is pivotally rotatable about the pin, wherein, when in use with the side rail, the pin is adjacent to the side rail and positioned outboard of the side rail.

According to other aspects of the present disclosure, a cross rail for securing to a side rail is provided. The cross rail includes a first clamping mechanism and a second clamping mechanism disposed on an opposite end of the cross rail from the first clamping mechanism. Each of the first clamping mechanism and the second clamping mechanism includes a frame, an inner clamp fixedly secured to the frame, and an outer clamp pivotally attached to the frame via a pin, wherein the outer clamp is pivotally rotatable about the pin, wherein, when in use with the side rail, the pin is adjacent to the side rail and positioned outboard of the side rail.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a perspective view of a cross rail in use with a side rail and with covers removed from clamping mechanisms of the cross rail, according to certain aspects of the disclosure.

FIG. 2 is a perspective view of a clamping mechanism of the cross rail of FIG. 1 in use with a sectioned portion of the side rail, according to certain aspects of the disclosure.

FIG. 3 is a side view of the clamping mechanism of the cross rail of FIG. 1 in use with the sectioned portion of the side rail, according to certain aspects of the disclosure.

FIG. 4 is detailed side view of the clamping mechanism of FIG. 1 in an open position while in use with the sectioned portion of the side rail, according to certain aspects of the disclosure.

FIG. 5 is a diagram illustrating the clamping mechanism as a first class lever, according to certain aspects of the disclosure.

FIG. 6 is a side view of an alternative clamping mechanism, according to certain aspects of the disclosure.

FIG. 7 is a perspective view of a second alternative clamping mechanism including a cam lever, according to certain aspects of the disclosure.

FIG. 8 is a side view of the second alternative clamping mechanism of FIG. 7 depicted in an open position, according to certain aspects of the disclosure.

FIG. 9 is a side view of the second alternative clamping mechanism of FIG. 7 depicted in a closed position, according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

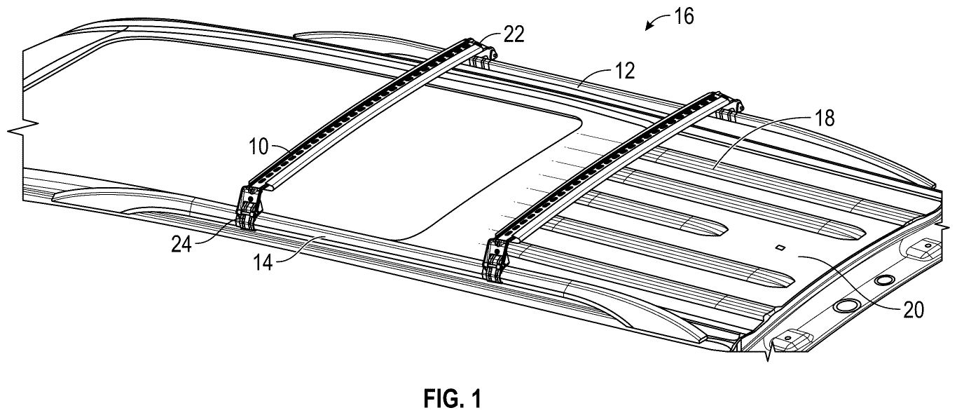

FIG. 1 illustrates a cross rail 10 in use with a first side rail 12 and a second side rail 14 of an automotive roof rack 16. The first side rail 12 and the second side rail 14 are mounted to a roof 18 of a vehicle 20. The first side rail 12 is disposed on the roof 18 along a passenger side of the vehicle 20 while the second side rail 14 is disposed on the roof 18 along a driver side of the vehicle 20. The cross rail 10 includes a first clamping mechanism 22 and a second clamping mechanism 24 disposed on an opposite end of the cross rail 10 from the first clamping mechanism 22.

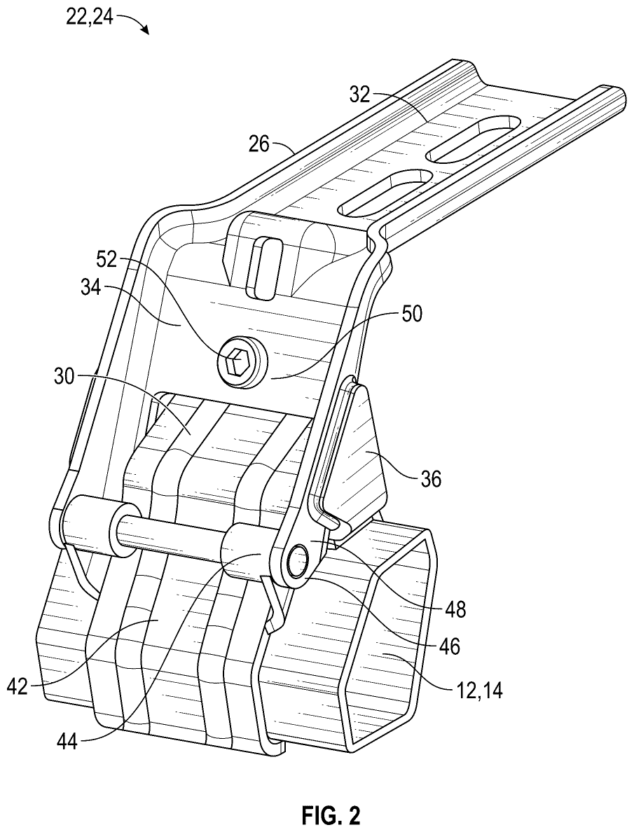

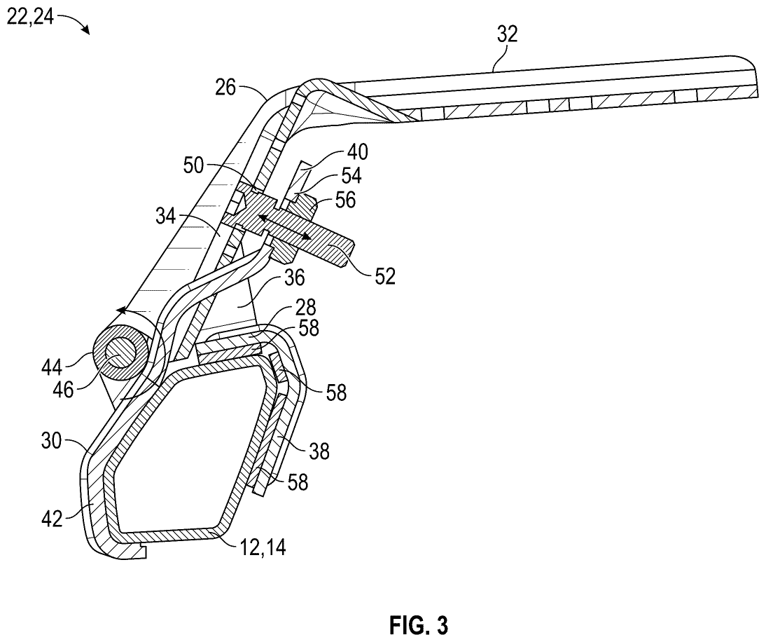

With reference to FIGS. 2 and 3, a clamping mechanism of the present disclosure, such as the first clamping mechanism 22 and the second clamping mechanism 24, will now be described in detail. Each of the first clamping mechanism 22 and the second clamping mechanism 24 include a frame 26, an inner clamp 28, and an outer clamp 30. The frame 26 can be formed by, but is not limited to, stamping. The frame 26 includes an arm 32, which angularly transitions into a flange 34. The inner clamp 28 includes a protuberance 36 and an inner jaw 38 that extends from the protuberance 36. The protuberance 36 of the inner clamp is fixedly secured to an inner side of the flange 34 of the frame 26. In certain aspects, the protuberance 36 of the inner clamp 28 is welded to the flange 34. The arm 32 of the frame 26 is secured to an end of the cross rail 10. In aspects, the arm 32 of the frame 26 is bolted to the end of the cross rail 10. In certain other aspects, the arm 32 of the frame 26 can be integrally formed with the end of the cross rail 10.

The outer clamp 30 includes a tongue 40 and an outer jaw 42 that extends from the tongue 40. The outer clamp 30 includes a pin receptacle 44 that extends outwardly for receiving a pin 46 for pivotally attaching the outer clamp 30 to the flange 34 of the frame 26. In certain aspects, the frame 26 includes a pivot carrier 48 outwardly extending from the flange 34, in which the pivot carrier 48 aligns with the pin receptacle 44 of the outer clamp 30 such that the pin 46 is received by the pivot carrier 48 and the pin receptacle 44 to pivotally attach the outer clamp 30 to the frame 26. In such a manner, the outer clamp 30 is pivotally rotatable about the pin 46.

The outer jaw 42 of the outer clamp 30 faces outwardly from the outward side of the flange 34 of the frame 26 while the tongue 40 of the outer clamp 30 faces substantially inwardly from the inward side of the flange 34 of the frame 26. A screw carrier 50 is disposed through the flange 34 of the frame 26 for receiving a screw 52. The tongue 40 of the outer clamp 30 includes an aperture 54 disposed therethrough for receiving the screw 52. The screw carrier 50 aligns with the aperture 54 in such a manner that the screw 52 is received by both, and a nut 56 is threaded onto the screw 52 such that the tongue 40 of the outer clamp 30 is in mechanical association with the flange 34 of the frame 26 when the screw 52 is tightened and untightened. In certain aspects, the nut 56 is securely fixed to the inboard-facing side of the tongue 40. In accordance with this configuration, the clamping mechanism, such as the first clamping mechanism 22 and the second clamping mechanism 24, acts as a first class lever when the screw 52 is tightened. In other aspects, two screws are utilized instead of one to increase the clamp loading.

In certain aspects, a padding 58 is affixed to the outboard-facing side of the inner jaw 38 for increased friction when in use with a side rail, such as the first side rail 12 and the second side rail 14. The padding 58 can be made of, but is not limited to, rubber.

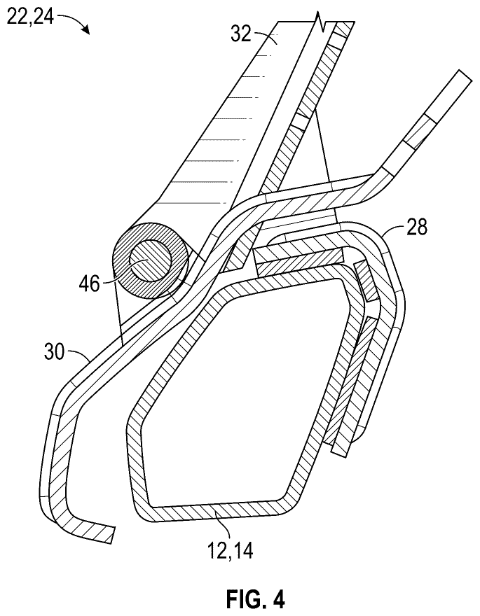

FIG. 4 illustrates the clamping mechanism, such as the first clamping mechanism 22 and the second clamping mechanism 24, in an open position with the screw 52 removed for clarity. In the open position, with the screw 52 loosened or removed, the outer jaw 42 of outer clamp 30 is pivotally rotatable outwardly with respect to the inner clamp 28 to provide appropriate clearance for the clamping mechanism, such as the first clamping mechanism 22 and the second clamping mechanism 24, to be positioned over and around the side rail, such as the first side rail 12 and the second side rail 14, so that the side rail is positioned between the inner clamp 28 and the outer clamp 30.

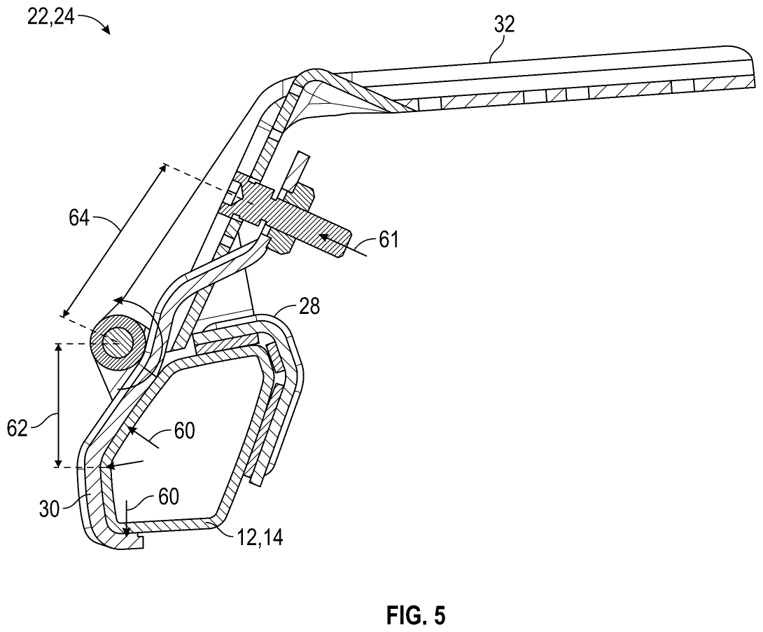

In use, once the clamping mechanism, such as the first clamping mechanism 22 and the second clamping mechanism 24, of the cross rail 10 is positioned over and around the side rail, such as the first side rail 12 and the second side rail 14, the screw 52 is tightened to secure the cross rail 10 to the side rail, as will be described further with particular reference to FIG. 5. With the frame 26 and the inner clamp 28 both being static with respect to the outer clamp 30, the tongue 40 of the outer clamp 30 pivotally moves outwardly towards the inboard-facing side of the flange 34 of the frame 26 as applied force is generated by the tightening of the screw 52. This applied force results in the outer clamp 30 rotating about the pin 46 (e.g., pivot point) causing the outer jaw 42 to pivotally move inwardly towards the inner clamp 28 and come into contact with the side rail, such as the first side rail 12 and the second side rail 14, as the outer jaw 42 of the outer clamp 30 is moved towards the inner jaw 38 of the inner clamp 28. The screw 52 is tightened until the clamping mechanism, such as the first clamping mechanism 22 and the second clamping mechanism 24, is secured to the side rail, such as the first side rail 12 and the second side rail 14, such that resultant forces 60 are acting against the inboard-facing side of the outer jaw 42 of the outer clamp 30 including a downward resultant force. The pin 46 (e.g., pivot point) is designed to be positioned adjacent and outboard of the side rail, such as the first side rail 12 and the second side rail 14, such that a short moment arm 62 of the clamping mechanism, such as the first clamping mechanism 22 and the second clamping mechanism 24, is less than a moment arm of applied force 64 of the clamping mechanism such that the resultant forces 60 are increased on the clamping surfaces of the clamping mechanism, such as the first clamping mechanism 22 and the second clamping mechanism 24, compared to conventional clamps. In other words, when the screw 52 is torqued and the cross rail 10 is clamped the clamping mechanism (e.g., the system), such as the first clamping mechanism 22 and the second clamping mechanism 24, is in equilibrium. The sum of the moments about the pivot (e.g., the pin 46) is equal to zero such that the moment created by the applied force over the distance from the pivot (e.g., moment arm of applied force 64) is the same as the moment of the resultant force over the short moment arm distance (e.g., the short moment arm 62). Accordingly, the resultant forces 60 will be higher than the applied force 61 since the short moment arm 62 of the resultant forces 60 is shorter than the moment arm of the applied forces 64. Because the pin 46 (e.g., pivot point) is positioned outboard of the side rail, the grip of clamping mechanism, such as the first clamping mechanism 22 and the second clamping mechanism 24, on the side rail continues to improve as force is added above the pin 46 (e.g., the screw 52 is tightened), which is an improvement over conventional clamps employing third class lever designs. In such third class lever designs, additional force (e.g., torque) on the screw, which is located below the pivot point, can lead to distortion of its outer clamp reducing clamp surface engagement with the side rail. Moreover, in such third class lever designs, the pivot is above the applied force such that its applied force moment arm is short and its resultant force moment arm is much longer (the longer moment arm produces a much lower resultant force clamping the side rail).

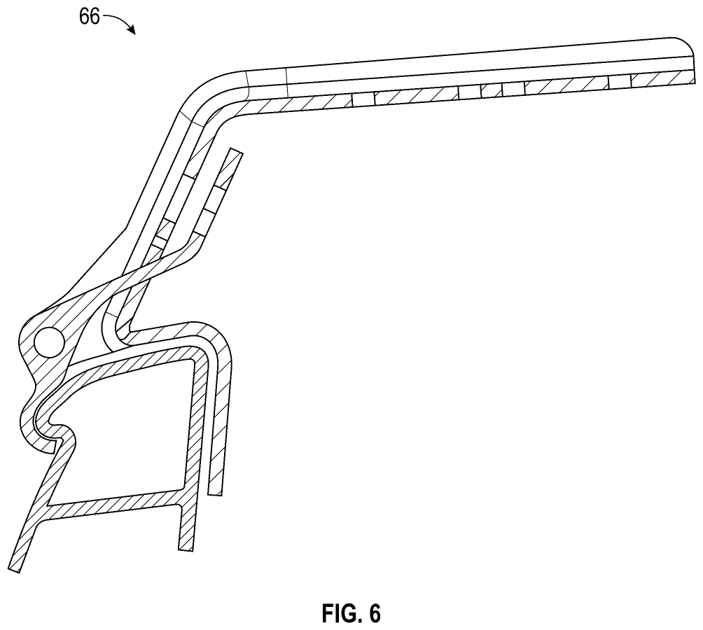

Referring to FIG. 6, an alternative clamping mechanism 66 is illustrated that can be used for flush mounted side rails. While this alternative clamping mechanism encompasses the first class lever principles and arrangements as described above for the first clamping mechanism 22, which can be used for raised side rails with respect to the roof 18 of the vehicle 20, the contours of the outer clamp and the inner clamp are designed to engage flush mounted side rails.

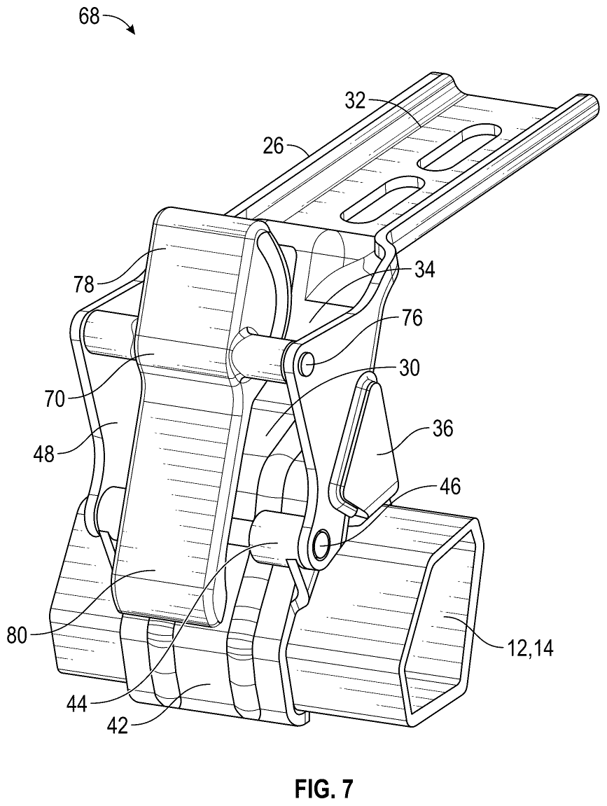

In certain aspects, as illustrated in FIGS. 7-9, a second alternative clamping mechanism 68 includes a cam lever 70 and a bolt 72 with a cam follower 74 that replaces the screw 52 of the clamping mechanisms 22, 24 shown in FIG. 2 to apply the loading above the pin 46 (e.g., pivot point) to actuate clamping. While most of the components of the second alternative clamping mechanism 68 are similar to the clamping mechanisms 22, 24 of FIG. 2, the cam lever 70 will be described in more detail below.

The cam lever 70 pivotally rotates about a cam pivot pin 76, which rotatably connects the cam lever 70 to the flange 34 of the frame 26. The cam lever 70 includes a body 78 and a handle 80 that extends from the body 78. The cam lever 70 includes an arcuate slot 82 that is disposed through the body 78 and is designed to mechanically receive the cam follower 74 of the bolt 72. In certain aspects, the bolt 72 is fixedly attached to the tongue 40 of the outer clamp 30 and extends through the flange 34 of the frame 26 such that the cam follower 74 is mechanically received by the arcuate slot 82.

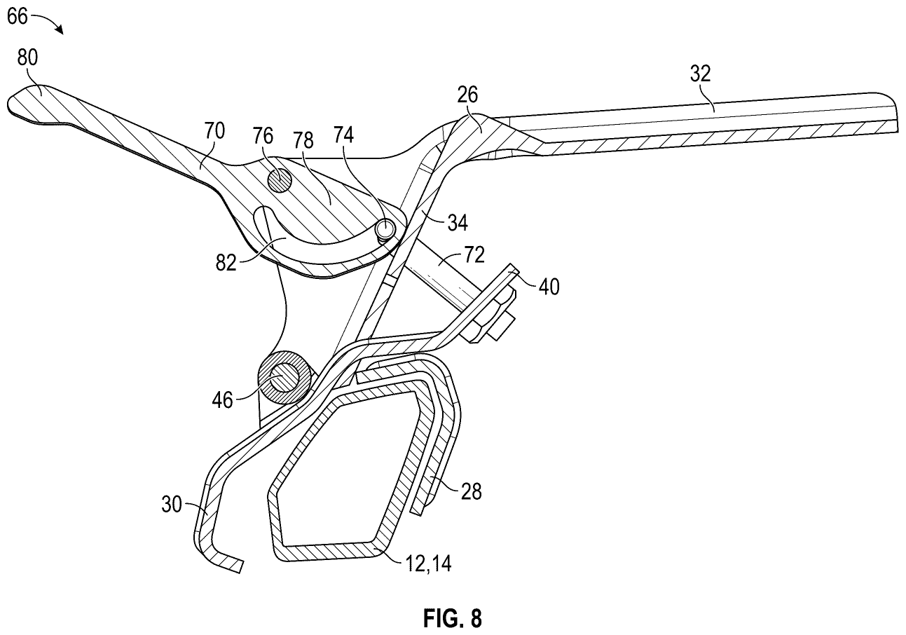

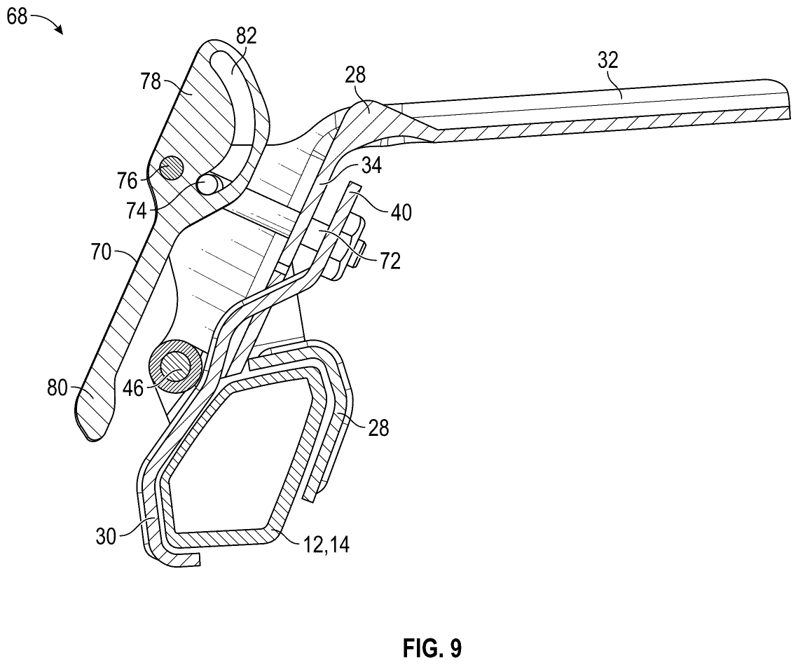

In the open position, as illustrated in FIG. 8, the second alternative clamping mechanism 68 can be positioned over and around the side rail, such as the first side rail 12 and the second side rail 14, so that the side rail is positioned between the inner clamp 28 and the outer clamp 30. From here, the second alternative clamping mechanism 68 can be actuated from the open position to the closed position (see FIG. 9) by applying force to the handle 80 such that the cam lever 70 rotatably pivots around the cam pivot pin 76 causing the cam follower 74 to travel within and along the arcuate slot 82 forcing the tongue 40 of the outer clamp 30 towards the flange 34 of the frame 26, which, in turn, causes the outer clamp 30 to rotate about the pin 46 and forces the outer jaw 42 into secure contact with the side rail, such as the first side rail 12 and the second side rail 14.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A clamping mechanism for securing a cross rail to a side rail, the clamping mechanism comprising:
a frame;
an inner clamp fixedly secured to the frame; and
an outer clamp pivotally attached to the frame via a pin, wherein the outer clamp is pivotally rotatable about the pin, wherein, when in use with the side rail, the pin is adjacent to the side rail and positioned outboard of the side rail.

2. The clamping mechanism of claim 1, wherein the outer clamp comprises a tongue and an outer jaw extending from the tongue, wherein the tongue is in mechanical association with the frame.

3. The clamping mechanism of claim 2, further comprising a screw, wherein the screw is received by the frame and the tongue of the outer clamp, wherein applied force is generated via tightening of the screw.

4. The clamping mechanism of claim 3, wherein the outer jaw of the outer clamp pivotally moves towards the inner clamp when the screw is tightened.

5. The clamping mechanism of claim 4, wherein, when in use with the side rail, a downward resultant force is acting against the outer jaw via tightening of the screw.

6. The clamping mechanism of claim 1, wherein the frame comprises an arm and a flange angularly transitioning from the arm, wherein a short moment arm is less than a moment arm of applied force.

7. The clamping mechanism of claim 1, further comprising padding affixed to the inner clamp.

8. A cross rail for securing to a side rail, the cross rail comprising:
at least one clamping mechanism, wherein the at least one clamping mechanism comprises
a frame,
an inner clamp fixedly secured to the frame, and
an outer clamp pivotally attached to the frame via a pin, wherein the outer clamp is pivotally rotatable about the pin, wherein, when in use with the side rail, the pin is adjacent to the side rail and positioned outboard of the side rail.

9. The cross rail of claim 8, wherein the outer clamp comprises a tongue and an outer jaw extending from the tongue, wherein the tongue is in mechanical association with the frame.

10. The cross rail of claim 9, further comprising a screw, wherein the screw is received by the frame and the tongue of the outer clamp, wherein applied force is generated via tightening of the screw.

11. The cross rail of claim 10, wherein the outer jaw of the outer clamp pivotally moves towards the inner clamp when the screw is tightened.

12. The cross rail of claim 11, wherein, when in use with the side rail, a downward resultant force is acting against the outer jaw via tightening of the screw.

13. The cross rail of claim 8, wherein the frame comprises an arm and a flange angularly transitioning from the arm, wherein a short moment arm is less than a moment arm of applied force.

14. The cross rail of claim 8, further comprising padding affixed to the inner clamp.

15. A cross rail for securing to a side rail, the cross rail comprising:
a first clamping mechanism; and
a second clamping mechanism disposed on an opposite end of the cross rail from the first clamping mechanism, wherein each of the first clamping mechanism and the second clamping mechanism comprise
a frame,
an inner clamp fixedly secured to the frame, and
an outer clamp pivotally attached to the frame via a pin, wherein the outer clamp is pivotally rotatable about the pin, wherein, when in use with the side rail, the pin is adjacent to the side rail and positioned outboard of the side rail.

16. The cross rail of claim 15, wherein the first clamping mechanism and the second clamping mechanism are bolted to the cross rail.

17. The cross rail of claim 15, wherein the first clamping mechanism and the second clamping mechanism are integrally formed with the cross rail.

18. The cross rail of claim 15, wherein the outer clamp comprises a tongue and an outer jaw extending from the tongue, wherein the tongue is in mechanical association with the frame.

19. The cross rail of claim 18, wherein each of the first clamping mechanism and the second clamping mechanism further comprise a screw, wherein the screw is received by the frame and the tongue of the outer clamp, wherein applied force is generated via tightening of the screw.

20. The cross rail of claim 19, wherein, when in use with the side rail, a downward resultant force is acting against the outer jaw via tightening of the screw.
